(19) United States
(12) Patent Application Publication
(10) Pub. No.: US 2004/0084517 A1
(43) Pub. Date: May 6, 2004

(54) Method and apparatus for writing information to a tire pressure monitoring sensor

(76) Inventors: Glen Harm, Fraser, MI (US); Ronald Singer, Warren, MI (US)

Correspondence Address: HARNESS, DICKEY & PIERCE, P.L.C., P.O. BOX 828, BLOOMFIELD HILLS, MI, 48303, US

(21) Appl. No.: 10/287,977

(22) Filed: Nov. 5, 2002

(51) Int. Cl. G06F 17/00

(52) U.S. Cl. 235/375

(57) ABSTRACT

A method and apparatus are provided for writing tire information to a tire pressure monitoring sensor.

### FIELD OF THE INVENTION

The present invention relates to tire pressure monitoring sensor and more particularly to a method and apparatus for writing information to a tire pressure monitoring sensor.

### BACKGROUND OF THE INVENTION

Tire pressure monitoring systems have been developed, including a tire pressure monitor sensor that is mounted to each wheel for sending signals to a central receiving unit aboard a vehicle for providing information regarding the tire pressure and temperature. Each of the tire pressure monitor sensors includes a respective radio frequency transmitter that transmits an RF signal. The RF signal includes both an identifier code and an indicator of tire pressure. A tire pressure monitor system of this type is disclosed in U.S. Pat. No. 5,600,301.

During mounting of a tire onto a wheel, it is often desirable to track information regarding the tire which can be useful with regard to tire recalls or generally to tire traceability with regard to mounting the tires to a specific vehicle. Accordingly, it is desirable in the art to provide a method for tracking tire information with respect to the vehicle to which the tire is mounted.

### SUMMARY OF THE INVENTION

The present invention provides a method and apparatus for writing tire information to a tire pressure monitoring sensor. Once the information is written to the tire pressure monitoring sensor, the information can be retrieved from the tire pressure monitor sensor by a central vehicle controller that can store the information. The present invention includes an information retrieval system for reading information regarding a tire. A processor unit is in communication with the information retrieval system for receiving information regarding the tire. An information writing system is provided for writing the information regarding the tire to the tire pressure monitor sensor.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a wheel having a tire pressure monitor sensor mounted thereto according to the principles of the present invention;

FIG. 2 is a schematic layout of a tire pressure monitor system installation and tire mounting assembly layout according to the principles of the present invention; and

FIG. 3 is a schematic layout of a conveyer system including a method and apparatus for writing information to a tire pressure monitoring sensor according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

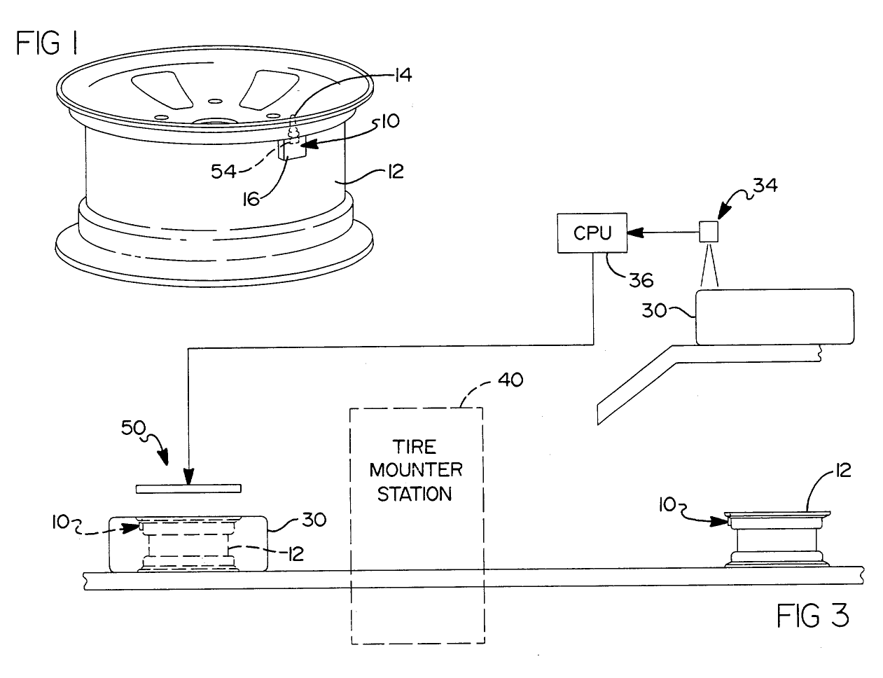

As shown in FIG. 1, a tire pressure monitor sensor 10 is mounted to a wheel 12. The tire pressure monitor sensor 10 includes a valve stem 14 and a sensor body 16 attached thereto. The valve stem 14 is provided with a threaded portion adjacent to a rubber seal that extends through an opening in the wheel 12. A threaded nut is threadedly engaged with the threaded portion of the valve stem 14 in order to secure the TPM sensor 10 to the wheel 12. The tire pressure monitor sensor 10 includes a pressure transducer and transmitter which transmit both an identification signal and a tire pressure signal to be read by a receiver antenna of a central controller.

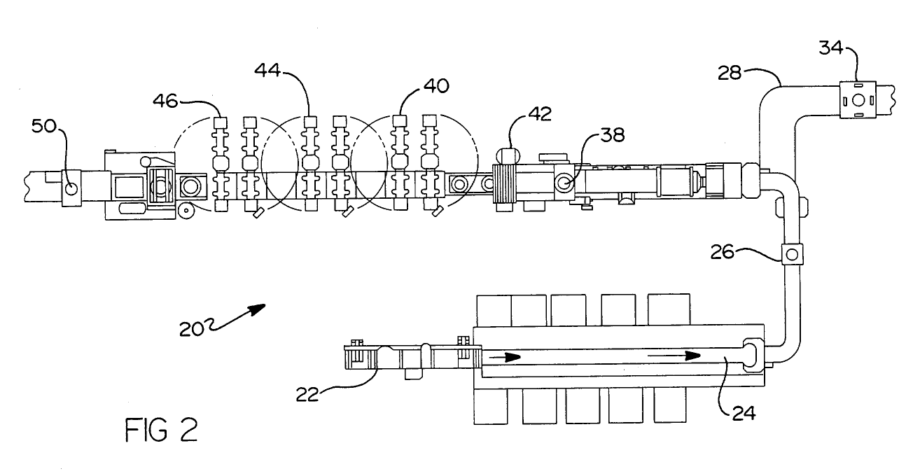

With reference to FIG. 2, a tire pressure monitor sensor assembly system and tire mounting assembly system is shown generally indicated by reference numeral 20. The assembly system includes a tire pressure monitor sensor installation station 22 at which a wheel 12 is loaded by an operator onto a wheel conveyer 24 and a tire pressure monitor sensor 10 is installed onto the wheel 12. After the tire pressure monitor sensor 10 is installed at the installation station 22, the wheel 12 is then carried along the wheel conveyer 24 to a wheel vision station 26 which is optionally provided for confirming the presence of a wheel 12 on the conveyer 24.

A tire conveyer 28 is provided for carrying tires 30 to be mated with the wheels 12. An information retrieval system 34 is provided for reading information from the tire. The information retrieval system 34 can include a bar code reader or other information retrieval mechanisms such as a 2-D label reader or an RFID tag reader. An RFID tag is a passive transmitter chip that is generally used for information storage and retrieval. For each of the above different information retrieval systems, the tire is provided with an associated bar code label, 2-D label or RFID tag. The information retrieved by the information retrieval system 34 can include an identifier code that can be used in connection with a stored database to retrieve information such as the lot (or batch) number, tire size, speed and load ratings, month and year of manufacture, and a measured conicity value or weight value. This information can also be stored on the bar code, 2-D label or RFID tag.

The information retrieval system 34 is connected to a processor unit 36 (FIG. 3) and provides the tire information to the processor unit 36. After the wheel vision station 26, the wheel 12 is passed to an orientation station 38 in which the wheel 12 is properly oriented for tire installation. The wheel 12 is then passed onto the mounter station 40 where the wheel 12 is mated with a tire 30 which passes through a soaper/loader station 42, as is known in the art, and the tire is mounted to the wheel by the tire mounter station 40. After the tire mounter station 40, the wheels 12 with mounted tires 30 pass through a matcher station 44, as is known in the art, and then to an inflater station 46 at which the tires 30 are inflated.

The tire 30 is then passed to an information writing station 50 for writing the tire information regarding the tire to the tire pressure monitor sensor 10. The information writing station 50 includes a transmitter 52 in the form of an antenna that transmits the tire information to a receiver 54 (FIG. 1) of the tire pressure monitor sensor 10 for storage therein. The tire information is then readable from the tire pressure monitor sensor 10 at any point desirable. In particular, the tire information can be downloaded to the vehicle controller upon assembly of the wheels onto the vehicle and activation or initial set-up of the vehicle central processor unit. The tire information can also be stored along with a vehicle identification number by the vehicle manufacturer so that the specific tires installed on a vehicle can be kept track of for future recall or any other future data or tracking requirements.

As an alternative, the tire pressure monitor sensor 10 can be provided with a download port and the information writing station 50 can be provided with a download connection for writing the tire information to the tire pressure monitor sensor 10 with a direct connection.

It should be understood that the sequence of writing tire information to the tire pressure monitoring sensor 10 can be performed after the tire is mounted to the wheel or prior to installation of the tire. The use of a download connection, as discussed above, would be most readily accomplished by writing the tire information to the tire pressure monitoring sensor 10 via a direct connection before the tire 30 is mounted to the wheel 12 and possibly prior to mounting the tire pressure monitoring sensor 10 to the wheel 12. It is important, however, that the tire 30 and tire pressure monitoring sensor 10 are properly tracked to ensure that the correct sensor 10 is mounted to the wheel 12 on which the corresponding tire 30 is mounted.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus for writing information to a tire pressure monitor sensor, comprising:
an information retrieval system for reading information regarding a tire;
a processor unit in communication with said information retrieval system for receiving information regarding the tire from said information retrieval system; and
an information writing system for writing said information regarding the tire to said tire pressure monitor sensor.

2. The apparatus according to claim 1, wherein said information retrieval system includes a bar code reader.

3. The apparatus according to claim 1, wherein said information retrieval system includes a 2-D label reader.

4. The apparatus according to claim 1, wherein said information retrieval system includes a transmitter chip reader.

5. The apparatus according to claim 1, wherein said information writing system includes a transmitter.

6. The apparatus according to claim 1, wherein said information writing system includes a download connection.

7. The apparatus according to claim 1, wherein said tire pressure monitor sensor includes a receiver for receiving information from said information writing system.

8. The apparatus according to claim 1, wherein said tire pressure monitor sensor includes a download port for receiving information from said information writing system.

9. A method for writing information to a tire pressure monitoring sensor, comprising the steps of:
reading information from a tire regarding the tire; and
writing said information regarding the tire to said tire pressure monitor sensor.
